(19) United States
(12) Patent Application Publication
(10) Pub. No.: US 2008/0219495 A1
(43) Pub. Date: Sep. 11, 2008

(54) Image Comparison

(75) Inventors: Geoffrey J. Hulten, Lynwood, WA (US); Stephen Miller, Woodinville, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/684,449

(22) Filed: Mar. 9, 2007

(51) Int. Cl. G06K 9/00

(52) U.S. Cl. 382/100

(57) ABSTRACT

Image comparison techniques are described to compare an image with a database of image information. In an implementation, an image is converted to normalized intensity pixels which are shingled to determine individual shingle hash values. Interesting shingle hash values may be implemented as a fingerprint for comparison with fingerprints of known images. Further, the image fingerprint may be hashed to extract a hash table for use in identifying the acceptability of the image. In implementations, the techniques may be used to identify the acceptability of the image in order to flag or block image transfer.

### BACKGROUND

The proliferation of email and computing networks such as the Internet (the World Wide Web) unfortunately has lead to an increase in unacceptable activities. Mass marketing email, or “spam”, campaigns may deliver messages to users who do not wish to receive solicitations and consume email provider resources.

In relatively benign cases these messages are merely annoying and slow the passage of legitimate email correspondence. In other cases, some messages are fraudulent, contain unacceptable content, or are illegal. Examples include email falsely encouraging the recipient to purchase worthless stocks or other securities; adult content delivered to minors; child pornography; fraudulent financial schemes (e.g. schemes which request a small sum of money for the promise of a gift); email including URL links to bogus web pages (e.g., email phishing); and so on.

Similarly, unacceptable material may be communicated over provider networks and computing resources in contradiction of user agreement. For example, most service provider agreements request that the user refrain from communicating unacceptable content.

Another example of an unacceptable activity is “phishing,” which may involve generating a phony web page, to misdirect consumers in order to steal information or direct consumers away from a legitimate web page to a web page which is controlled by a third party. For example, a fake bank or merchant web page is created to confuse a visitor into disclosing personal and financial information.

Unacceptable image content is difficult to screen on networks. Recently, a growing number of unacceptable text messages have been transmitted as an image file mat contains an image of the message. For instance, instead of sending a text email message, these messages are converted into an image to avoid screening. Trivial modifications to an unacceptable image may inhibit filtering. For example, random dots or minor color variations are included to avoid filtering. Filtering unacceptable images may consume a large amount of processing capability to determine if an image is acceptable.

### SUMMARY

Image comparison techniques are described which may permit identification of an image that has been altered to avoid detection. In an implementation, an image is converted to normalized intensity pixels which are shingled to determine individual shingle hash values. Interesting shingle hash values may be implemented as an image fingerprint for comparison with image fingerprints of known unacceptable images. Further, the image fingerprint may be hashed to extract a hash table for use in identifying the acceptability of the image.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to implement image comparison.

FIG. 2 is an illustration of shingled image in an exemplary implementation.

FIG. 3 is a general illustration of a subdivided image.

FIG. 4 is a flow diagram depicting a procedure in an exemplary implementation in which an image fingerprint is implemented for comparison.

FIG. 5 is a flow diagram depicting a procedure in an exemplary implementation in which a hash table is implemented for comparison.

### DETAILED DESCRIPTION

Overview

Techniques are described to implement “fuzzy” image comparison to identify the acceptability of images. According to these techniques, an original image is converted to an intensity image having a limited range of values. The image may be shingled by grouping together a plurality of pixels. These individual shingle signatures may be used to determine intensity variations occurring within the group of pixels. For example, the intensity within a shingle may change six times in a thirty pixel row with a hash generated for the shingle. A set of shingle values may be selected to generate a map or image fingerprint the image. For instance, a selected group of ten shingle hashes are implemented to identify the image. In further implementations, a hash table may be extracted to streamline the determination. A variety of other implementations are also contemplated, further discussion of which may be found in the following discussion.

In the following discussion, an exemplary environment is first described that is operable to implement fuzzy image comparison. Exemplary procedures are then described that may be employed in the exemplary environment, as well as in other environments.

Exemplary Environment

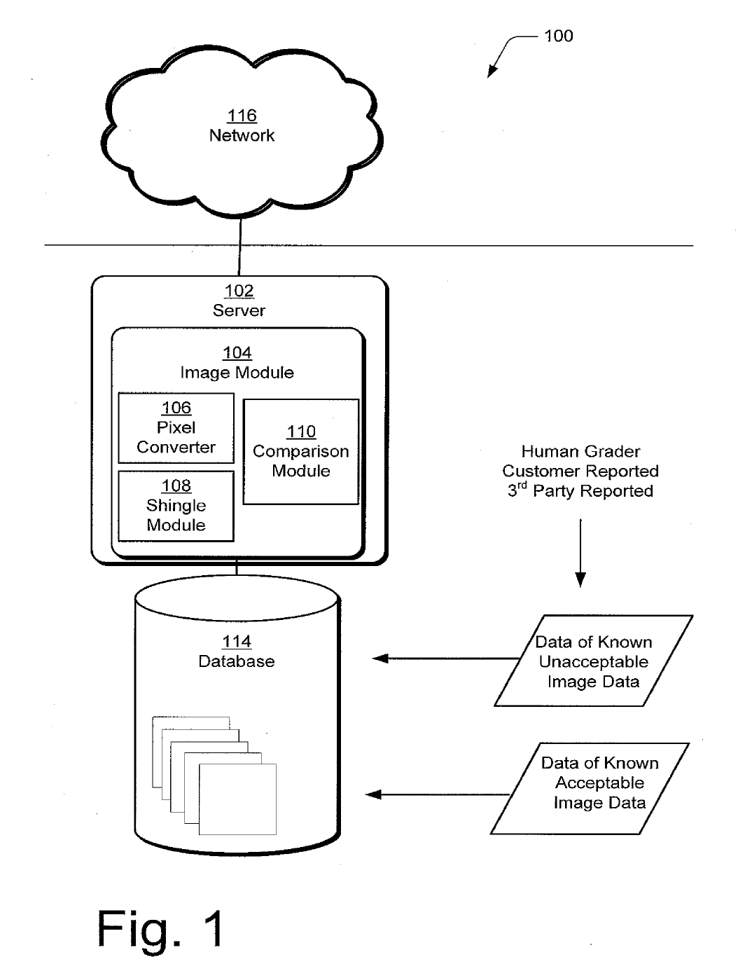

FIG. 1 is an illustration of an environment 100 in an exemplary implementation employing a server 102 configured to implement fuzzy image comparison. Images include, but are not limited to, image files, web pages, messages, content having non-text or pixilated content. In implementations, the server 102 provides access or facilitates communication over a network, such as the Internet, an intranet, or an email communication system. In other instances, a server is dedicated to filtering network communications. For example, a server may be operated by a third party in order to identify unacceptable Internet content.

An image module 104 is included in the server 102. The image module 104 is configured to intercept an image based communication. For example, a filtering server 102 implementing fuzzy image comparison is coupled to a provider server so that a requested web page is determined to be legitimate prior to forwarding to the client.

In the present implementation, the image module 104 is configured to “normalize” the original image to an intensity or grey-scale image having a limited number of grey shades. Normalizing may minimize the likelihood of random variations effecting identification. Additionally, the image may be normalized to a standard resolution, aspect ration, and so on. Converting a color original image to an intensity or grey-scaled image may allow for identification of a color manipulated image. In an implementation, the image module may include a pixel converter module 106 for converting pixels into intensity based pixels or grey-scale pixels. For example, a change in the background color may not affect identification of the message when implementing normalized intensity pixels or grey-scaled pixels.

Additionally, utilizing a limited grey palette for the grey-scale image may promote efficient processing without diminishing the capability of the image module 104 to identify unacceptable images. In implementations, the number of available grey shades is adjustable to permit customization. In this way, the server 102 is adjustable to balance accuracy, speed and processing power dedicated to image comparison. Instead of generating a grey-scale image with hundreds of shade variations, for instance, the resultant image may have ten shades of grey to streamline processing over a grey-scale image having more grey shades or intensity values. The image module 104 may assign grey scale values according to a predetermined adjustment methodology. Grey-scaling may be applied to an image as a whole or applied in a coextensive fashion during shingling (discussed below).

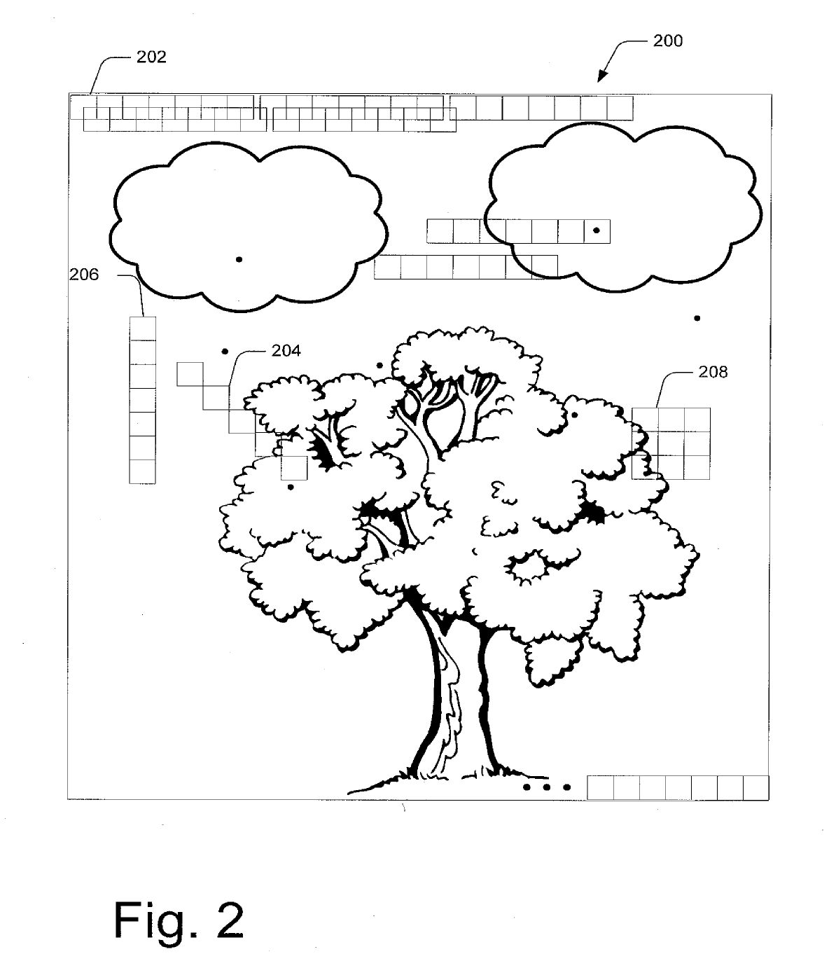

In the current implementation, the image module 104 is configured to determine an image fingerprint for the grey-scale image based on a set of the lowest hash values for interesting shingles of pixels. With reference to FIG. 2, for instance, the image module 104 examines a grey-scale image 200 by selecting a shingle of pixels 202, (e.g. thirty pixels in a lateral row). For example, a shingle module 108 may be included in the image module to shingle the grey-scale image as discussed herein. Other shingle arrangements include a diagonal configuration 204, a vertical arrangement 206, a predetermined pattern, such as a square 208, and so on. In the present example, the grey-scale image is examined by “rastering” thirty pixel lateral shingles over the image. The rastered shingles may also overlap. Overlap may occur in other shingling configurations as well For instance, shingling commences with the upper-left most pixels and extends laterally for a specified number of pixels, such as pixels 1 through M. Shingling may be repeated at 2−M+1 until the entirety of the image is examined. In the foregoing manner, a particular pixel may be encompassed in one or more shingles as the starting point of the “shingle” is moved laterally by one pixel (in the present case). Other sampling techniques and combinations may be used. For instance, utilizing a set of intersecting diagonal shingles in combination with a base linear shingle pattern.

In the current embodiment, the image module 104 determines, a shingle value, or signature, based on the grey-scale or intensity variation occurring within the shingle. For example, in a white “paper” background or an unchanging blue sky, intensity variation does not occur and the shingle may be eliminated, or ignored as “uninteresting.” Uninteresting may include, but are not limited to, shingles which do not include intensity variations, singles which include very few intensity variations, shingles which have intensity variation that are associated with a large fraction of known benign images. The image module 104 may also ignore commonly occurring benign signatures, e.g., those signatures associated with a tree, the sun, a cloud or a random dot on a page. In this way, additional time consuming and processor intensive analysis may be avoided. Additionally, the image module 104 may be configured to heuristically determine acceptable, or non-offending signatures from a source of acceptable image data.

In the current example, the image module 104 obtains hash values for the shingle signatures. While a message digest five (MD5) based algorithm is contemplated, other suitable algorithms are available, such as hashing algorithms that can convert the normalized pixel representation into a 128 bit value with low probability of collisions, and so on. The image module 104 may examine the shingles to determine an image fingerprint for the grey-scaled image. In the current example, the image module 104 obtains a set of the “lowest” hash values for the shingle signatures of interest. For example, an image fingerprint may be formed of the ten lowest shingle hash values for the shingles of interest for the image. Reoccurring low hash values may be culled to avoid repetition. Other statistical methodologies for determining an image fingerprint are also contemplated.

The image module 104 may be configured to interrogate the database 114 to determine if the image fingerprint matches an included unacceptable image or data corresponding to a known unacceptable image. For example, a comparison module 110 may be implemented to access the database 114 having image fingerprints of known unacceptable images for comparison with an image in question. In further situations, the database may include acceptable image fingerprints for comparison. Acceptable images may be utilized to minimize false positives. The in-question image fingerprint may be considered a match if at least a portion of the image fingerprint matches an unacceptable image fingerprint included in the database 114. If, for example, an image fingerprint is made up of ten shingle hash values, a threshold value of two or three matching hash values may be considered a sufficient match to identify the original image as unacceptable. In a further example, a ten-out-of-ten match would likely indicate the image fingerprint is a high-probability match. In the first case, the differentiation between the two image fingerprints may be due to the inclusion of stray dots, trivial changes included to avoid screening, and other image modifications to the image.

In further implementations, the image module 104 is configured to generate a hash table from the image fingerprint. Correspondingly, a database would include hash tables associated with known unacceptable images. Utilization of a hash table, of hashed shingle values, may reduce the amount of data used to identify the image. For instance, a hash table is retained instead of retaining an image fingerprint in-which the relevant signature data is maintained, such the signature and the signature's location in integer space.

The server 102 may be directly connected or connect through the network 116 to one or more feeds, or sources, which update the database 114 including known unacceptable image data. Image data may include the image; an identifying image characteristic, such as an image fingerprint or hash table. For instance, a third party provider may screen images to determine which violate a standard or images which correspond to images in which legitimate coping is dubious (e.g., a bank web page, a financial service company image, and so on). Additional data feeds may be included for providing acceptable image data to the database 114 in order to distinguish acceptable/unacceptable content. For example, a source provides known acceptable images to aid in heuristically identifying common acceptable shingles.

The data feeds may be derived from a variety of sources including organizations, individuals (e.g., reporting “this is spam”), and so on. Additional information may be implemented. For instance, a value or rank may be included based on how the image is known to be unacceptable. In this way, an identified image may include information indicating the status of the party reporting the image, e.g. individuals, or an organization. This information may aid in determining at what threshold level the image will be blocked. A ranking of how likely the data is to offend may also be included. In this manner, offensive content is more likely blocked than merely annoying content. Additionally, a uniform resource locator, an internet protocol (IP) address or other identification may be maintained for images within the database. For example, a URL may be associated with a bank web page so that a third party attempting to direct others to a “duplicate web page” may be subject to “blocking” or a “warning” as the third party URL does not correspond with a URL for the legitimate web page. In a further example, a warning may be attached to an email including an image associated with a financial institution if the source of the email does not correspond with identification formation associated with the institution.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer readable media, memory devices, e.g., memory. The module may be formed as hardware, software, a hybrid of hardware and software, firmware, stored in memory, as a set of computer readable instructions embodied in electronically readable media, etc.

A variety of techniques may be used to identify and compare an image, further discussion of which may be found in relation to the following exemplary procedures.

Exemplary Procedures

The following discussion describes an identification methodology that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. A variety of other examples are also contemplated.

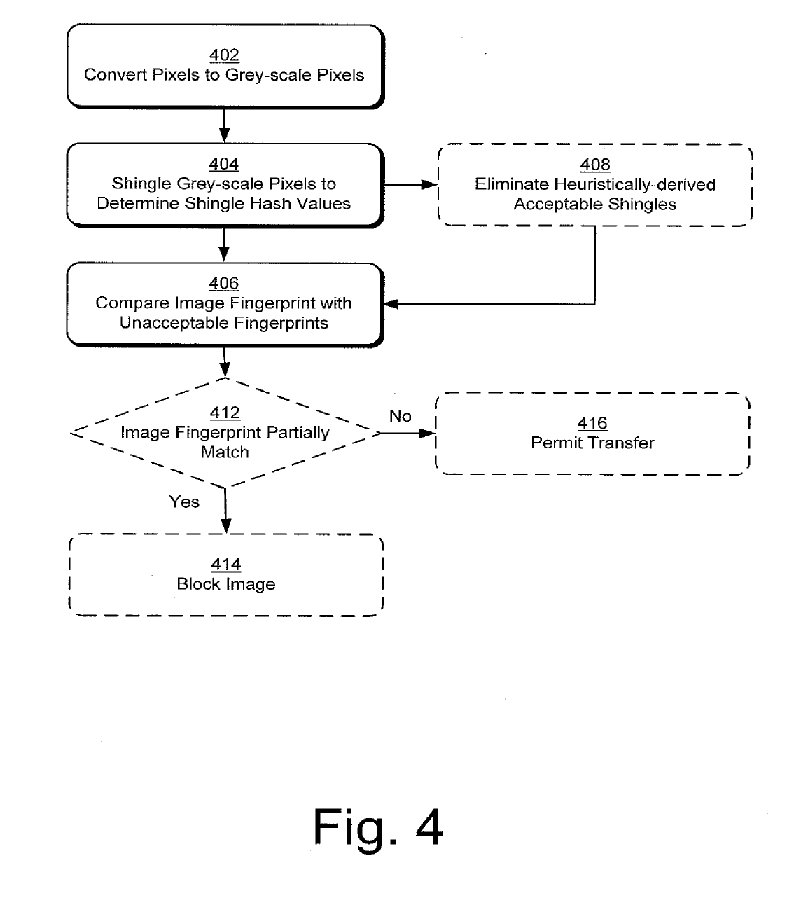

Referring to FIG. 4, an image comparison procedure is discussed. The image may be obtained by intercepting an image transferred over a network. For example, the image is data forming web page requested by a client. The pixels forming the image may be converted 402 to grey-scale or an intensity image. In another example, the original image is converted to a grey-scale image having a limited set of values. For example, the pixels forming the original image are converted enmasse to grey-scale pixels. The grey-scale image may be resized to a standard size as well. Conversion 402 may include converting an image to a grey-scale image or converting pixels forming the original image to grey-scale pixels as the image is shingled 404. Limiting the possible intensity values may reduce the processing capability and time to manipulate the image. For example, an original image having a thousand intensity variations is adjusted to ten or less shade variations. In this manner, a one to one thousand intensity scale may be normalized to a ten value scale with values occurring within a 100 value range being lumped within a unit of the resultant scale. While a ten value grey scale is discussed, the procedure may implement a wide variety of grey-scale values as desired based on desired performance characteristics and required accuracy.

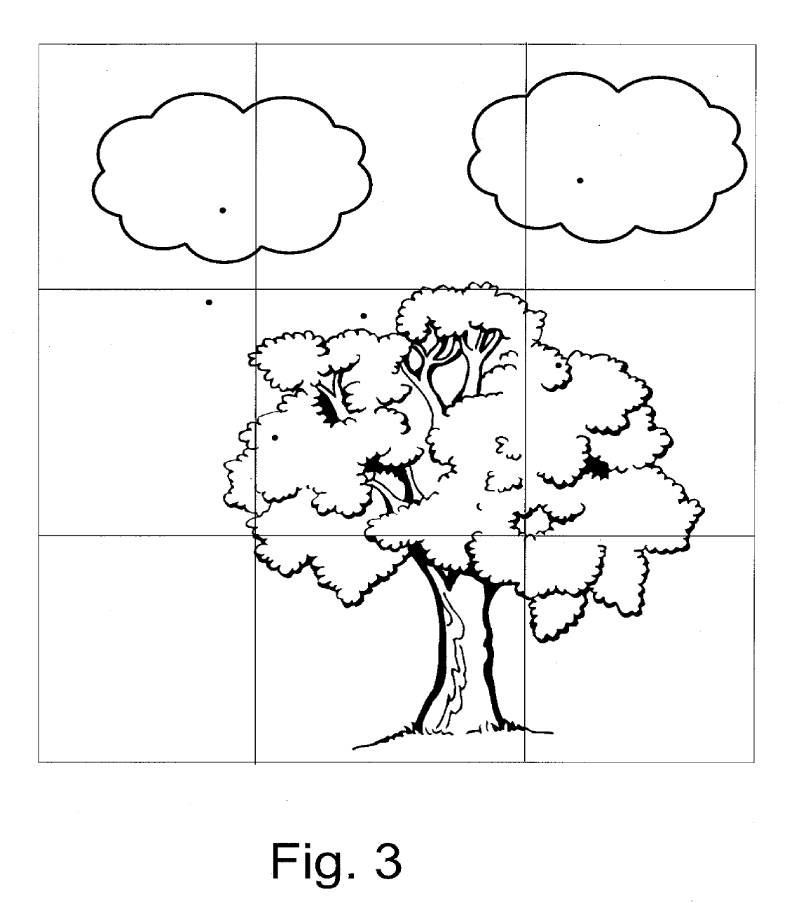

The grey-scaled pixels are shingled 404 to determine individual shingle hash values. For example, a hash value representing the intensity variation within the shingle, e.g., a value representing three grey-scale changes within the shingle. While shingling 404 is currently accomplished utilizing a thirty pixel lateral row, other shingle configurations, and combinations of shingle configurations and sizes are contemplated. For example, utilizing combinations of shingle configurations, sampling particular areas of the image, utilizing various numbers of pixels, and so on. Individual shingle values, or signatures, may be hashed to determine a shingle hash value for utilization in determining an image fingerprint derived from the original image, e.g., web page, email, etc. In this way, insertion of stray dots or other modifications will not impact identification of the image. In further instances, shingling occurs on a subdivided original (e.g., FIG. 3) image to minimize variations inserted in other segments of the image from impacting identification of the underlying image. For example, an original image may be segmented and the constituent segments analyzed to determine a finger print for the original image. While a message digest five (MD5) based algorithm is contemplated, other suitable algorithms are available, such as hashing algorithms that can convert the normalized pixel representation into a 128 bit value with low probability of collisions, and so on. The hashed shingle values may form an image fingerprint so that the underlying image is identifiable even with changes included to avoid detection. In further implementations, heuristically-derived acceptable shingle hash values are implemented to eliminate acceptable shingle signatures/hash values. In this manner, commonly occurring acceptable content is ignored in-favor of more relevant shingles which may more accurately characterize the image. For example, the lowest shingle hash values, associated with shingles of interest, within an image.

The shingled hash values may be compared 406 with similarly obtained data from unacceptable images (which may include images which are “unsuitable” for use by a third party), acceptable images, images may be used for comparison. In the current instance, a set of the lowest occurring shingle hash values is utilized as an image fingerprint or map for comparison with corresponding data from known unacceptable images. In further situations, the image may be identified as “unsuitable” for duplication. For example, a web page for a credit card company, a bank, a university, and so on may be identified as “unsuitable” if the image is not associated with a Uniform Resource Locator (URL) or other identifier for the institution. For example, an image may be blocked or flagged if the image shingle hash value matches similarly obtained data from a financial institution and the images is not being transmitted from a URL associated with the financial institution.

Selecting a set of the hash values may ensure that small changes, e.g., inclusion of a stray dot or similar minor changes, do not change the image fingerprint sufficiently to avoid characterization. For instance, the analyzed image fingerprint is compared with known unacceptable image fingerprints derived in a similar manner as the image being analyzed. Other methodologies may be utilized as well to compare the image. Further, heuristically obtained acceptable shingles may be eliminated 408 or ignored. In the current implementation, duplicate low shingle hash values are eliminated to improve image characterization. The original image may be considered a match 412 if the image fingerprint at least partially matches a known unacceptable image 414. For example, a match of seven out of ten shingle values is considered a match, with the remaining variation being attributed to modifications inserted in an attempt to avoid detection. If the image at least partially matches 414 a known unacceptable image, transmission of the image may be blocked or a warning inserted to alert the client of the image's status. The level at which an image may be blocked may vary. For example, in a real-time network application, this may include blocking a website including the image, closing a web page including the image, flagging or blocking the website or page. In an instant messaging scenario, the transferred image may be blocked, the user account may be flagged for screening purposes, and so on.

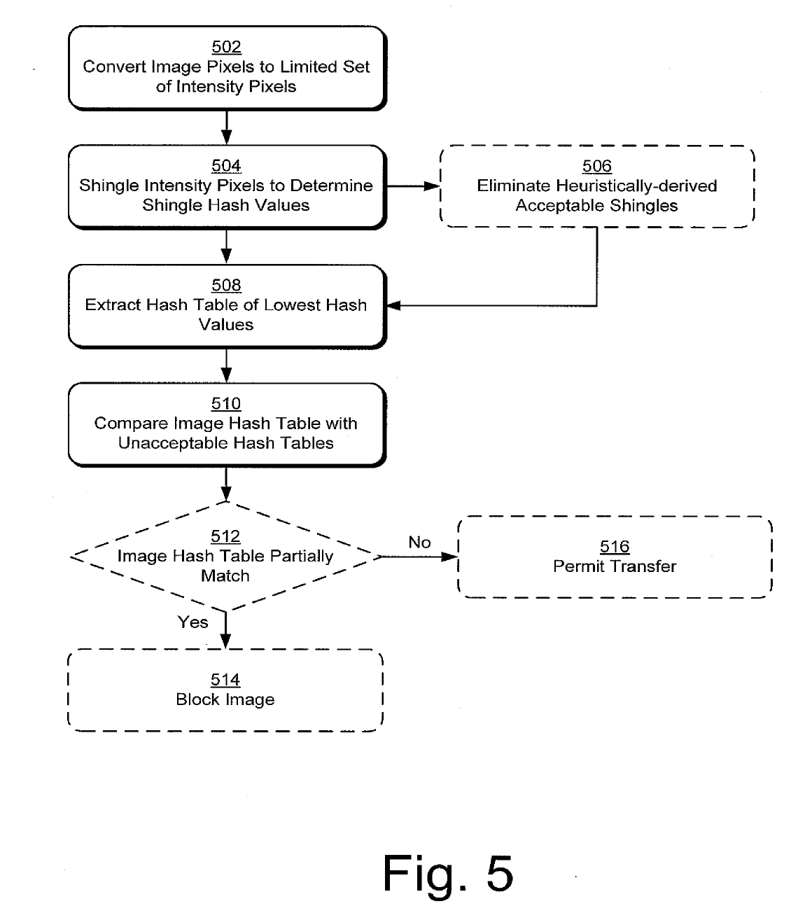

Referring to FIG. 5, in a similar manner as discussed with respect to FIG. 4, one or more computer-readable media may be implemented to cause a processor to perform the acts of, obtaining the original image pixels, forming a web page, an email message, web posting, etc., may be converted 502 to a limited set of normalized intensity pixels or grey-scaled pixels for analysis. Intensity scaling may occur on the image as a whole or as the image is shingled. The converted pixels are shingled 504 to determine a hash value for the shingles of interest, i.e., shingles which define the image. Unvarying shingles may be ignored. Acceptable shingles may be eliminated 506 as well, such as through a heuristic determination.

In the present implementation, an image hash table of the lowest, non-repeating, shingle hash values is extracted 508 from the individual shingle hash values. Extracting 508 a hash table or super shingling the shingle hash values may allow for identification of the image without maintaining an image fingerprint data as a map, to identify the underlying image. For example, ten shingle hash values are extracted and hashed into a hash table so that the signatures are maintained as cross-pairs which results in 45 hashes (e.g., permutations of the underlying 10 signature pairs, e.g., shingle hash value in integer space). In this way, the shingle signatures are hashed and rehashed into a hash table. The extracted 508 hash table may be compared 510 with similarly obtained data from unacceptable images. The extracted hash table may be compared to individual hash tables of known images or to a hash table including hash tables of images included in the database. For example, the extracted hash table may be compared to a hash table associated with the known acceptable images in the database. In this example, the hash table associated with known acceptable images is formed of hash tables of individual images. Thus, a single match between the hash table of the examined image and a known unacceptable image hash table may be a match between two of the original hashes within the image fingerprint when utilizing cross-pairs. Similarly, a “3 pair” methodology may be utilized in which a hash is taken of 3 shingle hashes with a match between the image in question and a image in the database indicates a match of three shingle hashes. A threshold hash table match may result in the image being blocked 514. For example, a partial match 512 of between 2-3 items may be sufficient to identify the original email image as spam. Other methodologies are contemplated to balance accuracy and processing power and/or data storage capabilities.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
converting pixels, forming an image, to normalized intensity pixels selected from a set of intensity values;
shingling the normalized intensity pixels to determine individual shingle hash values; and
comparing an image fingerprint of non-repeating shingled hash values with known image fingerprints.

2. The method as described in claim 1, further comprising utilizing heuristically-derived shingle hash values to eliminate acceptable shingles.

3. The method as described in claim 1, wherein the image fingerprint is a set of lowest shingle hash values.

4. The method as described in claim 1, wherein shingling includes implementing a hashing algorithm.

5. The method as described in claim 1, wherein the image is selected from a group consisting of an email message, a web page and a web posting.

6. The method as described in claim 1, wherein the image is a subdivided image.

7. The method as described in claim 1, further comprising blocking transmission of the image when the fingerprint at least partially matches at least one of a known unacceptable image fingerprint or an unsuitable image fingerprint.

8. The method as described in claim 1, further comprising scaling the image to a standard size.

9. The method as described in claim 1, wherein shingling includes implementing at least two different configurations selected from a group consisting of a lateral shingle, a vertical shingle, a group shingle and a diagonal shingle.

10. The method as described in claim 1, further comprising eliminating uninteresting shingles.

11. One or more computer-readable media comprising computer-executable instructions that, when executed, direct a computing system to,
convert image pixels to intensity based pixels selected from a set of intensity values;
shingle the converted pixels to determine individual shingle hash values of interest; and
extract an image hash table of lowest non-repeating shingle hash values to compare with image hash tables of known images.

12. The one or more computer-readable media as described in claim 11, further comprising implement heuristically-derived shingle hash values to eliminate acceptable shingles.

13. The one or more computer-readable media as described in claim 11, wherein extract an image hash table includes implementing a hashing algorithm.

14. The one or more computer-readable media as described in claim 11, wherein the image pixels are included in at least on of an email message, a web page or a web posting.

15. The one or more computer-readable media as described in claim 11, further comprising block an image containing the image pixels when the image hash table at least partially matches a known image hash table.

16. The one or more computer-readable media as described in claim 11, wherein the method is performed on a service provider server.

17. A system comprising:
an image module configured to normalize a transferred image to an intensity image having a set of intensity values, the image module being configured to determine an image fingerprint based on a set of hash values for shingles of interest, included in the transferred image; and
a database to store a plurality of image fingerprints, the database being configured for interrogation by the image module to determine when the transferred image matches at least partially one of the image fingerprints included in the plurality of image fingerprints.

18. The system as described in claim 18, wherein the image module is configured to heuristically derive acceptable shingle hash values for elimination.

19. The system as described in claim 18, wherein the transferred image is at least one of an email message, a web page or a web posting.

20. The system as described in claim 18, wherein the set of hash values for shingles of interest is the lowest set of hash values for shingles of interest occurring in the intensity image.
